(19) United States
(12) Patent Application Publication
(10) Pub. No.: US 2026/0268222 A1
(43) Pub. Date: Sep. 10, 2026

(54) TRAINING DATA GENERATION DEVICE, LEARNING SYSTEM, TRAINING DATA GENERATION METHOD, AND TRAINING DATA GENERATION PROGRAM

(71) Applicant: TOYOTA JIDOSHA KABUSHIKI KAISHA, Toyota-shi Aichi-ken (JP)

(72) Inventor: Koutarou AOYAGI, Mishima-shi Shizuoka-ken (JP)

(73) Assignee: TOYOTA JIDOSHA KABUSHIKI KAISHA, Toyota-shi Aichi-ken (JP)

(21) Appl. No.: 19/553,956

(22) Filed: Mar. 2, 2026

(30) Foreign Application Priority Data
Mar. 4, 2025 (JP) 2025-033672

(51) Int. Cl. G06N 20/00

(52) U.S. Cl. CPC G06N 20/00

(57) ABSTRACT

A training data generation device generates training data used in machine learning. The training data generation device stores first recognition data obtained by using a first sensor provided on a first vehicle. The training data generation device executes: a recognition data estimation process to estimate second recognition data obtained by using a second sensor provided on a second vehicle located in a measurement range of the first sensor at a target event, based on the first recognition data in the target event; a behavior calculation process to calculate a behavior of the second vehicle in the target event based on the first recognition data in the target event; and a training data generation process to generate training data by associating the second recognition data estimated by the recognition data estimation process with the behavior of the second vehicle calculated by the behavior calculation process.

### CROSS-REFERENCE TO RELATED APPLICATION

The present application claims priority under 35 U.S.C. §119 to Japanese Patent Application No. 2025-033672, filed on Mar. 4, 2025, the contents of which application are incorporated herein by reference in their entirety.

### TECHNICAL FIELD

The present disclosure relates to a technology for generating training data suitable for generating machine learning models that infer the behavior of vehicles.

### BACKGROUND ART

Patent Document 1 describes a playback device technology aimed at enabling users to accurately grasp the situation around a vehicle at the time of an event occurrence retrospectively. According to Patent Document 1, the acquisition unit of the playback device obtains peripheral images of the vehicle and detection data obtained from various sensors of the vehicle during driving. The event detection unit detects events based on the detection data. Then, the image generation unit generates playback images directed toward the target identified according to the event at the time the event occurs, based on the peripheral images.

### List of Related Art

Patent Document 1: Japanese Patent Application Laid-Open No. 2014-134912

### SUMMARY

To achieve the required inference accuracy in the inference of vehicle behavior using machine learning such as deep learning, a large amount of training data related to the actual behavior performed by the vehicle under various situations is necessary. In addition, training data for machine learning must include not only the vehicle behavior itself but also data from various sensors installed in the vehicle, such as a camera, that were recorded while the vehicle performed that behavior. In machine learning model-based autonomous driving technology, it is necessary to comprehensively collect and retain data from sensors installed in the vehicle and data on the behavior of the vehicle in a wide variety of situations, including rare events with low occurrence frequency.

Nevertheless the technology described in Patent Document 1 allows creation of images aimed at a particular target at the instant an event occurs, but it does not provide sensor data of that target from its perspective, nor does it produce data linking the sensor data of the target with the behavior of the target. For this reason, it is not possible to obtain training data suitable for generating machine learning models intended for application to autonomous driving technology.

An object of the present disclosure is to provide a technology that is possible to improve the efficiency of comprehensively collecting data from vehicle-mounted sensors and the behavior data of the vehicle under a wide variety of situations, and to efficiently generate training data suitable for generating machine learning models to be applied to autonomous driving technology.

A first aspect of the present disclosure relates to a training data generation device to generate training data used in machine learning.

The training data generation device includes:

one or more storage devices; and

processing circuitry, wherein

the one or more storage devices are configured to store first recognition data obtained by using a first sensor provided on a first vehicle.

The processing circuitry is configured to execute:

a recognition data estimation process to estimate second recognition data obtained by using a second sensor provided on a second vehicle located in a measurement range of the first sensor at a target event, based on the first recognition data in the target event;

a behavior calculation process to calculate a behavior of the second vehicle in the target event based on the first recognition data in the target event; and

a training data generation process to generate training data by associating the second recognition data estimated by the recognition data estimation process with the behavior of the second vehicle calculated by the behavior calculation process.

A second aspect of the present disclosure relates to a learning system.

The learning system includes:

the above-mentioned training data generation device; and

a model generator to generate a trained model for inferring a behavior of a vehicle from recognition data obtained using a sensor provided on a vehicle, by using the training data generated by the training data generation process.

A third aspect of the present disclosure relates to a training data generation method executed by a computer of a training data generation device to generate training data used in machine learning.

The training data generation method includes:

a data storage process to store first recognition data obtained by using a first sensor provided on a first vehicle;

a recognition data estimation process to estimate second recognition data obtained by using a second sensor provided on a second vehicle located in a measurement range of the first sensor at a target event, based on the first recognition data in the target event;

a behavior calculation process to calculate a behavior of the second vehicle in the target event based on the first recognition data in the target event; and

a training data generation process to generate training data by associating the second recognition data estimated by the recognition data estimation process with the behavior of the second vehicle calculated by the behavior calculation process.

A fourth aspect of the present disclosure relates to a training data generation program.

The training data generation program is configured to cause a computer of the training data generation device to execute the above-mentioned training data generation method.

According to the present disclosure, it is possible to improve the efficiency of comprehensively collecting data from vehicle-mounted sensors and the behavior data of the vehicle under a wide variety of situations, and to efficiently generate training data suitable for generating machine learning models to be applied to autonomous driving technology.

### BRIEF DESCRIPTION OF DRAWINGS

FIG. 1 is a conceptual diagram explaining an overview of a training data generation device equipped with a learning system;

FIG. 2 shows an example of a hardware configuration that implements functions of the learning system;

FIG. 3 is a block diagram showing an example of a configuration of a vehicle that is the data collection target of the learning system;

FIG. 4 is a block diagram showing a configuration of the learning system;

FIG. 5 is a diagram explaining concept of synthetic scenes by the training data generation device.

### DETAILED DESCRIPTION

An embodiment of a training data generation device, a learning system, a training data generation method, and a training data generation program according to the present disclosure will be described with reference to the attached drawings. In each of the drawings, identical or corresponding parts are given the same signs, and the repeated description will be simplified or omitted when appropriate. In the description made hereinafter, for the sake of convenience, the positional relationship of each of structures may be expressed with reference to the states shown in the drawings. The present disclosure is not limited to the following embodiments, and each embodiment may be freely combined, any components of each embodiment may be modified, or any components of each embodiment may be omitted without departing from the gist of the present disclosure.

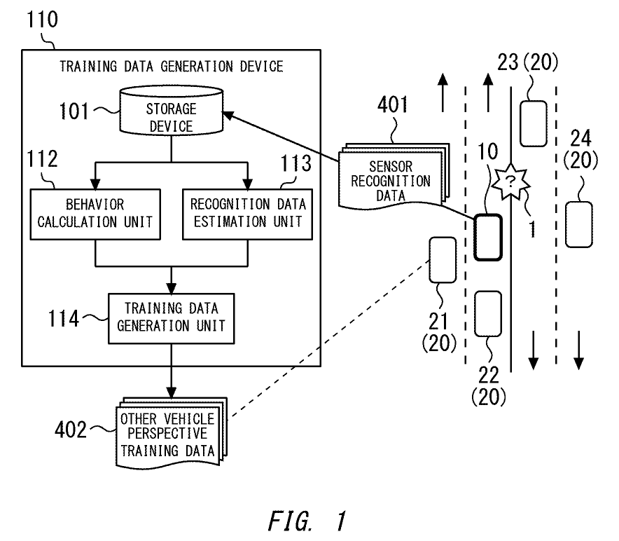

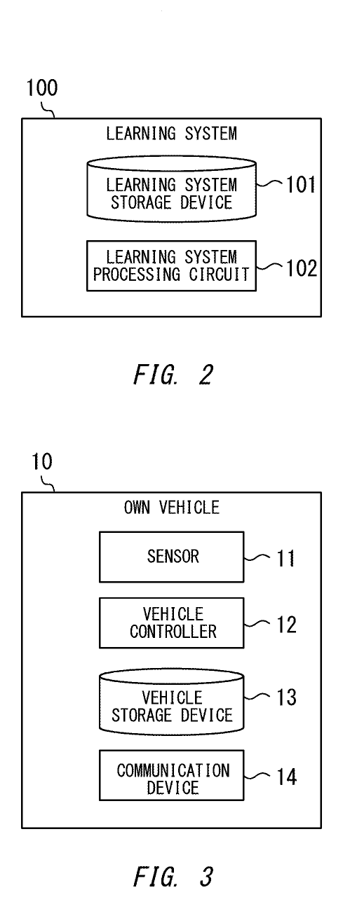

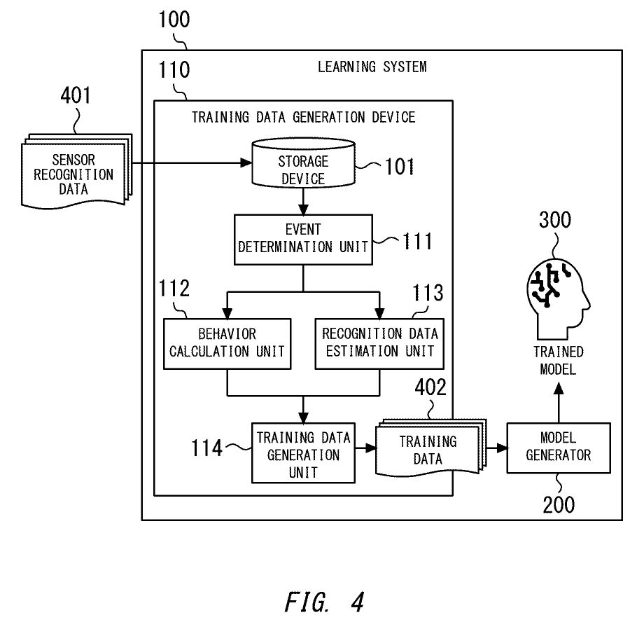

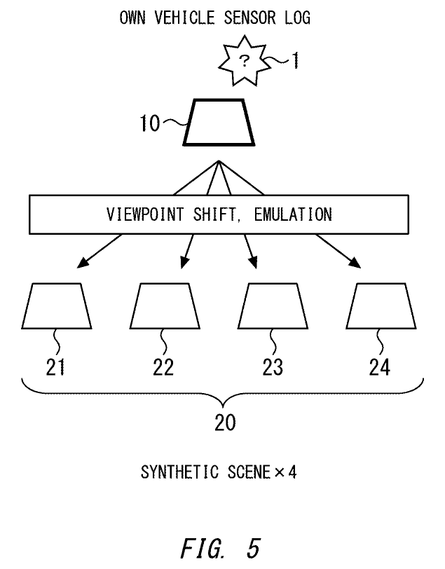

Referring to FIGS. 1 through 5, an embodiment of the present disclosure will be described. FIG. 1 is a conceptual diagram explaining an overview of a training data generation device equipped with a learning system; FIG. 2 shows an example of a hardware configuration that implements functions of the learning system; FIG. 3 is a block diagram showing an example of a configuration of a vehicle that is the data collection target of the learning system; FIG. 4 is a block diagram showing a configuration of the learning system; and FIG. 5 is a diagram explaining concept of synthetic scenes by the training data generation device.

The learning system 100 according to this embodiment is a system that generates a trained model 300 by machine learning for inferring a behavior of a vehicle from sensor recognition data 401 obtained using a sensor provided on the vehicle. The learning system 100 according to this embodiment includes a training data generation device 110 as shown in FIG. 1. The training data generation device 110 generates training data 402 used in machine learning for generating a trained model.

As shown in FIG. 2, the learning system 100 includes a computer provided with one or more learning system storage devices 101 and one or more learning system processing circuits 102. The learning system 100 includes the training data generation device 110 shown in FIG. 1 and other figures. The training data generation device 110 is composed of a computer that includes, as hardware, for example, the learning system storage device 101 and the learning system processing circuit 102.

The learning system processing circuit 102 executes various processes. The learning system processing circuit 102 is composed, for example, of a general-purpose processor, a dedicated processor, a CPU (Central Processing Unit), a GPU (Graphics Processing Unit), an ASIC (Application Specific Integrated Circuit), an FPGA (Field-Programmable Gate Array), an integrated circuit, a conventional circuit, or a combination of one or more of these. Processors, including transistors and other circuits, are examples of the learning system processing circuit 102. The learning system processing circuit 102 can also be referred to as circuitry or processing circuitry. Circuitry is hardware programmed to implement functions described in the present disclosure, or hardware that performs those functions.

The learning system storage device 101 is composed of storage media such as, for example, RAM (Random Access Memory), ROM (Read Only Memory), SSD (Solid State Drive), HDD (Hard Disk Drive), and the like.

The learning system storage device 101 stores various types of information necessary for executing processes of the learning system processing circuit 102. The learning system storage device 101 stores computer programs executable by the learning system processing circuit 102. The computer program is composed of a plurality of instructions that describe the processes to be executed by the learning system processing circuit 102. The computer program may also be recorded on a computer-readable recording medium. In the learning system 100, the learning system processing circuit 102 executes the computer program stored in the learning system storage device 101, and through the cooperation of the hardware and software of the learning system 100, the functions of the learning system 100, including the training data generation device 110, are implemented.

The learning system storage device 101 further stores the sensor recognition data 401. The sensor recognition data 401 is data obtained using sensors installed on a vehicle such as an automobile. In the present disclosure, among vehicles, a vehicle from which sensor recognition data 401 is collected is referred to as an own vehicle 10, and vehicles other than the own vehicle 10 are referred to as other vehicles 20. The number of own vehicles 10, which are the targets for collecting sensor recognition data 401, may be any number as long as it is one or more.

In FIG. 1, four other vehicles, namely the first other vehicle 21, the second other vehicle 22, the third other vehicle 23, and the fourth other vehicle 24, are illustrated as examples of other vehicles 20, however, the number of other vehicles 20 to be targeted may be any number equal to or greater than one, and is not limited to four. In the present disclosure, when collectively referring to the first other vehicle 21, the second other vehicle 22, the third other vehicle 23, and the fourth other vehicle 24 without distinction, the term "other vehicle 20" is used.

As shown in FIG. 3, the own vehicle 10 is equipped with a sensor 11, a vehicle controller 12, a vehicle storage device 13, and a communication device 14. The sensor 11 of the own vehicle 10 includes a recognition sensor. The recognition sensor is a sensor such as a camera, LiDAR, or millimeter-wave radar for recognizing external surrounding situations of the own vehicle 10. The sensor 11 of the own vehicle 10 may also include a state sensor. The state sensor is a sensor for detecting state quantities of the subject own vehicle 10 itself. The state quantities of the own vehicle 10 detected by the state sensor may include, for example, position, speed, acceleration, steering amount, throttle opening, brake operation amount, and the like.

The vehicle controller 12 controls actuators such as the engine and/or motor of the own vehicle 10, thereby controlling operations of the own vehicle 10, such as traveling, stopping, and steering. It is to be noted that the control performed by the vehicle controller 12 also includes auxiliary control relating to the driving of the own vehicle 10 by a driver. The vehicle storage device 13 stores data detected by the sensor 11 of the own vehicle 10 and the like. The communication device 14 is a communication interface that enables the own vehicle 10 to communicate with external entities. The learning system 100 can communicate with the own vehicle 10, for example, via a communication network, which is not shown in the drawings. The communication network is composed of, for example, wired communication systems, wireless communication systems, the Internet, and the like.

As described above, the learning system storage device 101 stores sensor recognition data 401. This sensor recognition data 401 is data of surrounding situation information of the own vehicle 10 obtained by using the sensor 11 installed on the own vehicle 10. The sensor recognition data 401 may be, for example, the data itself detected by the sensor 11, or data obtained by applying some processing to the data detected by the sensor 11. An example of the former is a camera image of the surroundings of the own vehicle 10 captured by the camera, which is the sensor 11. An example of the latter includes surrounding situation information data recognized by known recognition AI from the data detected by sensors 11 such as a camera, LiDAR, millimeter-wave radar, and the like.

The surrounding situation information of the own vehicle 10 includes information regarding a situation of an event 1 occurring around the own vehicle 10 and information regarding a situation of other vehicles 20 around the own vehicle 10. The event 1 that occurs around the own vehicle 10 is an occurrence that may potentially affect the operation of the own vehicle 10. Specific examples of event 1 include sudden appearance of a pedestrian, a bicycle, or an animal, fallen trees, collapse of surrounding structures, an accident involving two or more other vehicles 20, or involving a single other vehicle 20, and the like. Examples of information regarding a situation of event 1 occurring around the own vehicle 10 include a size of an obstacle in the event 1, a relative position and/or a relative velocity of the obstacle to the own vehicle 10, and the like. Examples of information regarding a situation of other vehicles 20 around the own vehicle 10 include a size of the other vehicles 20, a relative position and/or a relative velocity to the own vehicle 10, and the like.

The sensor recognition data 401 of the own vehicle 10 is transmitted to the learning system 100, for example, via the communication device 14 and communication network. The transmission of the sensor recognition data 401 to the learning system 100 may be performed in real time immediately after detection by the sensor 11, or it may be performed later. In a case where the sensor recognition data 401 is transmitted afterwards, the sensor recognition data 401 detected by the sensor 11 is once stored, for example, in the vehicle storage device 13. When collecting the sensor recognition data 401 after the fact, instead of transmitting it from the own vehicle 10 to the learning system 100, the sensor recognition data 401 may be retrieved from the vehicle storage device 13 by temporarily removing the vehicle storage device 13 from the own vehicle 10 and/or temporarily connecting the vehicle storage device 13 and the learning system 100. In this case, it is not necessary that the own vehicle 10 be equipped with the communication device 14.

The learning system storage device 101 may be additionally configured to store detection data from the state sensors of the own vehicle 10. That is, the learning system storage device 101 may further store data such as, for example, the position, speed, acceleration, steering amount, throttle opening, brake operation amount of the own vehicle 10.

In the present disclosure, the own vehicle 10, the sensor 11 provided on the own vehicle 10, and the sensor recognition data 401 obtained using the sensor 11 provided on the own vehicle 10 are respectively referred to as the first vehicle, the first sensor, and the first recognition data. Also, the other vehicle 20, the sensor provided on the other vehicle 20, and the sensor recognition data obtained using the sensor provided on the other vehicle 20 are respectively referred to as the second vehicle, the second sensor, and the second recognition data. Here, the second sensor does not necessarily have to match the sensor actually installed on the other vehicle 20, and a sensor does not have to be installed on the actual other vehicle 20. The second sensor may be a sensor that is assumed or presumed to be installed on the other vehicle 20, which is the second vehicle. For example, it may be assumed that the other vehicle 20 is equipped with a sensor equivalent to the sensor 11 of the own vehicle 10. Similarly, it is not necessarily required that the second recognition data coincide with the data obtained from sensors actually installed on the other vehicle 20.

The training data generation device 110 according to the present disclosure generates training data 402 used for machine learning. The training data 402 generated by the training data generation device 110 is mainly used for training (learning) machine learning models applied to autonomous driving technology of vehicles. The training data 402 generated by the training data generation device 110 associates the data obtained from the vehicle's sensors with the vehicle's behavior data at the specified event 1. By using such training data 402, for example, it is possible to generate a machine learning model that infers the behavior of the vehicle when encountering event 1 based on the data obtained from the vehicle's sensors.

The training data generation device 110 according to the present disclosure is implemented by the learning system processing circuit 102 executing the computer program stored in the learning system storage device 101 and, as shown in FIG. 4, includes the following functional units: an event determination unit 111, a behavior calculation unit 112, a recognition data estimation unit 113, and a training data generation unit 114.

The event determination unit 111 determines the event 1 to be targeted (hereinafter referred to as the “target event”). The event determination unit 111 may determine the target event either by allowing a user to specify it manually, or automatically by analyzing the data stored in the learning system storage device 101.

When the user manually specifies the target event, the training data generation device 110 is connected to a user interface (not shown) that includes a display device and an input device. The display device performs various displays in accordance with the output from the training data generation device 110. The display device is composed of, for example, a display, projector, head-mounted display (HMD), and the like. The input device receives various inputs from the user to the training data generation device 110. The input device is composed of, for example, a keyboard, pointing device, touchpad, switch, microphone, and the like. The user interface may be equipped with a touch panel that serves as both the display device and the input device. The training data generation device 110 may be a server accessible via a communication network. In this case, the user interface may be a user terminal (for example, a personal computer, smartphone, tablet, etc.) connected to the training data generation device 110 via a communication network.

For example, the event determination unit 111 obtains the sensor recognition data 401 of the own vehicle 10, that is, the first recognition data, from the learning system storage device 101, and displays the obtained first recognition data on the display device in time series. At this time, the event determination unit 111 may also obtain and display a state data of the own vehicle 10. Then, the user, while checking the displayed time-series data, operates the input device to specify start and end points of a desired event. The event determination unit 111 determines the target event based on the specified start and end points.

When the target event is determined automatically, the event determining unit 111 executes a target event determination process for determining the target event based on the first recognition data. In the target event determination process, the event determination unit 111 obtains the sensor recognition data 401 of the own vehicle 10, that is, the first recognition data, from the learning system storage device 101. Then, the event determination unit 111 determines the target event using the obtained first recognition data.

For example, the event determination unit 111 specifies a point in time at which the first recognition data satisfies a rare event condition. Then, the event determination unit 111 determines the period including this specified point in time as the target event. The rare event condition is predetermined. In the present disclosure, a rare event refers to an event that has an extremely low frequency or probability of occurring, being encountered, or being experienced during normal driving. In embodiments, a rare event is of a nature that is difficult to anticipate and is valuable because there are no prior records of it in the development of vehicle autonomous driving technology.

For example, the event determination unit 111 attaches descriptive text to the camera image of the first recognition data using generative AI (such as a multimodal large language model), and then, by using classification based on this descriptive text, determines an event that have not occurred before as a rare event. Alternatively, the event determination unit 111 may determine an event to be a rare event if a specific predetermined keyword (for instance, "unknown") is detected in the descriptive text attached by the generative AI or the like. Furthermore, as another example of the rare event condition, when the own vehicle 10 is equipped with a surrounding situation recognition function based on detection data from sensor 11 and a recognition result of an event by this surrounding situation recognition function is "Unknown," the event determination unit 111 may determine that the aforementioned event is a rare event.

Additionally, there may be a case where the own vehicle 10 is undergoing test driving or training driving for purposes such as autonomous driving and a safety driver is aboard the own vehicle 10. In this case, the safety driver can manually record information about the events encountered while driving. For example, when an event occurs during driving, the safety driver attaches a label corresponding to a content and an attribute of the event to a detection data from sensor 11 at the time of the event. If the safety driver encounters a rare event during driving, the safety driver adds a label indicating that this event is a rare event to a detection data from sensor 11 at the time of the rare event. The event determination unit 111 checks the label attached to the detection data from sensor 11, and if a label indicating that it is a rare event is attached, determines that the event related to the detection data is a rare event.

The recognition data estimation unit 113 executes the recognition data estimation process. The recognition data estimation process is a process for estimating second recognition data obtained by using the second sensor provided on the second vehicle located in a measurement range of the first sensor in the target event, based on the first recognition data in the target event. The recognition data estimation unit 113 first obtains, from the learning system storage device 101, the first recognition data of the first vehicle in the target event determined by the event determination unit 111. Next, the recognition data estimation unit 113 uses the obtained first recognition data to identify the second vehicle that was within the measurement range of the first sensor during the target event. Then, the recognition data estimation unit 113 estimates the second recognition data that can be obtained using the second sensor installed on the identified second vehicle.

The estimation of the second recognition data of the second vehicle may, for example, be performed by inference using a machine learning model, or by methods such as coordinate transformation (viewpoint shift) or emulation. In the case of inference using a machine learning model, for example, a pre-trained model that, when a camera image of the own vehicle 10 is input, infers and outputs an image of a scene taken from the viewpoint of the other vehicle 20 appearing in the camera image is prepared in advance, and by inputting the camera image of the own vehicle 10 to this pre-trained model, a camera image from the viewpoint of the other vehicle 20, which is the second recognition data, is obtained.

In addition, in the case of coordinate transformation (viewpoint shift) and/or emulation, for example, by applying a coordinate transformation (viewpoint shift)using the surrounding situation information of the first recognition data, position, speed, size, etc., of the second vehicle, the target event, other roadside structures, and the like as seen from the viewpoint of the first vehicle can be converted into surrounding situation as seen from the viewpoint of the second vehicle, that is, position, speed, size, etc., of the second vehicle other than this vehicle, the first vehicle, the target event, other roadside structures, and the like as seen from the viewpoint of the second vehicle. Then, in the surrounding situation from the viewpoint of the second vehicle, by emulating (imitating) detection data of the sensor provided on the second vehicle, the second recognition data obtained using the second sensor provided on the second vehicle can be estimated.

The second recognition data estimated in this way is data regarding the surrounding situation information as viewed from the second vehicle. In other words, the second recognition data include at least the status of the targeted event recognized from the second vehicle's perspective and the surrounding vehicle situation. As mentioned above, the second sensor needs not be identical to the sensors actually installed on other vehicle 20, and the second recognition data need not be identical to the data obtained from the sensors actually installed on the other vehicle 20. Therefore, the second recognition data can also be said to be surrounding situation recognition data that would have been obtained by sensors assumed to be installed on the other vehicle 20 (second vehicle) surrounding the own vehicle 10.

The behavior calculation unit 112 executes a behavior calculation process. The behavior calculation process is a process for calculating a behavior of the second vehicle that was within the measurement range of the first sensor in the target event, based on the first recognition data in the target event. First, the behavior calculation unit 112 obtains the first recognition data of the first vehicle in the target event decided by the event determination unit 111, from the learning system storage device 101. Next, the behavior calculation unit 112 uses the obtained first recognition data to identify the second vehicle that was within the measurement range of the first sensor during the relevant target event. Then, the behavior calculation unit 112 calculates the behavior of the identified second vehicle.

The calculation of the behavior of the second vehicle can be performed, for example, by obtaining the behavior of the second vehicle relative to the ground from the relative behavior of the second vehicle to the first vehicle through coordinate transformations using the following information. The behavior of the second vehicle to be calculated may include at least one of the travel trajectory, speed, acceleration, or the like of the second vehicle.

Information about the situation of the second vehicle included in the surrounding situation information of the first recognition data, namely, the relative position, speed, acceleration, and the like of the second vehicle as seen from the viewpoint of the first vehicle.

Information about the state of the own vehicle 10 included in the first recognition data, namely, the position of the first vehicle, (ground-referenced) speed, (ground-referenced) acceleration, and the like.

The execution order of the recognition data estimation process by the recognition data estimation unit 113 and the behavior calculation process by the behavior calculation unit 112 does not matter. These processes may be performed in parallel. Also, common processes in these operations, such as data acquisition from the learning system storage device 101 or identifying a second vehicle within the measurement range of the first sensor in the target event, may be performed collectively. Furthermore, the intermediate result of one process may be utilized in the other process. For example, the behavior of the second vehicle calculated by the behavior calculation process may be used in the recognition data estimation process.

The training data generation unit 114 executes a learning data generation process. The learning data generation process is a process for generating training data 402 by associating the second recognition data estimated by the recognition data estimation process with the behavior of the second vehicle calculated by the behavior calculation process. By associating the second recognition data estimated by the recognition data estimation unit 113 with the behavior of the second vehicle calculated by the behavior calculation unit 112, the relevant target event can be grasped as a scene experienced from the perspective of the second vehicle. The training data generation unit 114 generates and outputs a set of the second recognition data and the corresponding behavior of the second vehicle as training data 402 for scenes experienced from the perspective of the second vehicle.

As shown in FIG. 4, the learning system 100 includes a training data generation device 110 configured as described above, and a model generator 200. The function of the model generator 200 is implemented, for example, by the learning system processing circuit 102 executing a computer program stored in the aforementioned learning system storage device 101. Using the training data 402 generated by the training data generation unit 114, the model generator 200 generates the trained model 300 for inferring the behavior of a vehicle from recognition data obtained using sensors installed on the vehicle.

A known machine learning algorithm can be used to generate the trained model 300. For example, the model generator 200 generates the trained model 300 using a neural network, particularly a deep neural network (DNN), through supervised learning. The training data 402 used in this case includes ground-truth labels. In other words, the training data 402 is data in which recognition data obtained using sensors provided on the vehicle is associated with the behavior of the vehicle at the time the recognition data was obtained as the ground-truth label.

The model generator 200 trains the trained model 300 through supervised learning using such training data 402 with ground-truth labels, such that when recognition data obtained from sensors installed on the vehicle is input, the model outputs the behavior of the vehicle which corresponds to the ground-truth label attached to that recognition data. Accordingly, it is possible to generate the trained model 300 that infers the behavior of the vehicle when it encounters event 1 based on data obtained from the vehicle's sensors.

Both the recognition data and the vehicle behavior data included in the training data 402 are time-series data. The vehicle behavior data typically changes at or around the time of the occurrence of event 1, more precisely at or around the instant the sensor of the vehicle recognizes the event 1. The change referred to here means that the behavior after that point in time becomes different from the ordinary behavior that would be expected based on the behavior preceding that point. In embodiments, in order to generate the trained model 300 that can infer changes in vehicle behavior caused by such an event 1, the vehicle behavior data used as the ground-truth labels for the training data 402 may be taken from the point in time when the event 1 was recognized by the vehicle's sensor. However, if it is difficult to specify the point in time when the vehicle's sensor recognized event 1, the behavior data from the time when the vehicle's behavior changed significantly or discontinuously may be used as the ground-truth labels.

As described herein, the training data generation device 110 of the learning system 100 estimates sensor recognition data that would be obtained from the sensors of other vehicles 20 based on the sensor recognition data 401 obtained by using the sensor 11 of the own vehicle 10 during the specified event 1. Moreover, in the same event 1, the behavior of other vehicles 20 is calculated from the sensor recognition data obtained by using the sensor 11 of the own vehicle 10. Then, by associating the estimated recognition data of the other vehicle 20 with the calculated behavior of the other vehicle 20, data that pairs the recognition data and behavior as seen from other vehicles that encountered the same event 1 is obtained. Thus, for a single event 1, a synthetic scene is generated for each of the other vehicles 20 (second vehicles) that were around the own vehicle 10 (first vehicle), and the training data 402 is generated for each synthetic scene (see FIG. 5). In other words, by using the recognition data obtained from the sensors of some vehicles that have encountered a particular event or situation, it is possible to obtain data that combines recognition data and behavior seen from other vehicles that also encountered the same event or situation.

Specifically, when the own vehicle 10 encounters a rare event, it is highly likely that the surrounding other vehicles 20 also encounter a rare event. The rare event from the viewpoint of the surrounding other vehicles 20 differs from the rare event from the viewpoint of the own vehicle 10, thereby constituting a unique rare event. Generating multiple rare event synthetic scenes from a single rare event accelerates the collection of training data. Thus, it is possible to improve the efficiency of comprehensively collecting data from vehicle-mounted sensors and the behavior data of the vehicle under a wide variety of situations, including rare events with low occurrence frequency, and to efficiently generate training data suitable for generating machine learning models to be applied to autonomous driving technology.

What is claimed is:

1. A training data generation device to generate training data used in machine learning, comprising:
one or more storage devices; and
processing circuitry, wherein
the one or more storage devices are configured to store first recognition data obtained by using a first sensor provided on a first vehicle, and
the processing circuitry is configured to execute:
a recognition data estimation process to estimate second recognition data obtained by using a second sensor provided on a second vehicle located in a measurement range of the first sensor at a target event, based on the first recognition data in the target event;
a behavior calculation process to calculate a behavior of the second vehicle in the target event based on the first recognition data in the target event; and
a training data generation process to generate training data by associating the second recognition data estimated by the recognition data estimation process with the behavior of the second vehicle calculated by the behavior calculation process.

2. The training data generation device according to claim 1, wherein the processing circuitry is further configured to execute a target event determination process to determine the target event based on the first recognition data.

3. The training data generation device according to claim 2, wherein the processing circuitry is further configured to determine a period including a time point at which the first recognition data satisfies a predetermined rare event condition as the target event in the target event determination process.

4. A learning system comprising:
the training data generation device according to claim 1; and
a model generator to generate a trained model for inferring a behavior of a vehicle from recognition data obtained using a sensor provided on a vehicle, by using the training data generated by the training data generation process.

5. A training data generation method executed by a computer of a training data generation device to generate training data used in machine learning, comprising:
a data storage process to store first recognition data obtained by using a first sensor provided on a first vehicle;
a recognition data estimation process to estimate second recognition data obtained by using a second sensor provided on a second vehicle located in a measurement range of the first sensor at a target event, based on the first recognition data in the target event;
a behavior calculation process to calculate a behavior of the second vehicle in the target event based on the first recognition data in the target event; and
a training data generation process to generate training data by associating the second recognition data estimated by the recognition data estimation process with the behavior of the second vehicle calculated by the behavior calculation process.

6. A training data generation program to cause a computer of the training data generation device to execute the training data generation method according to claim 5.
